(19) United States
(12) Patent Application Publication
(10) Pub. No.: US 2015/0311513 A1
(43) Pub. Date: Oct. 29, 2015

(54) NEGATIVE ELECTRODE MATERIAL FOR LITHIUM ION SECONDARY BATTERIES, AND METHOD FOR EVALUATING SAME

(71) Applicant: NEC CORPORATION, Tokyo (JP)

(72) Inventors: Ryota YUGE, Tokyo (JP); Akio TODA, Tokyo (JP); Takashi MIYAZAKI, Toyko (JP)

(73) Assignee: NEC Corporation, Tokyo (JP)

(21) Appl. No.: 14/651,590

(22) PCT Filed: Nov. 21, 2013
(86) PCT No.: PCT/JP2013/081437

§ 371 Date: Jun. 11, 2015

(30) Foreign Application Priority Data
Dec. 17, 2012 (JP) 2012-274730

(51) Int. Cl. H01M 4/36; G01N 23/201; H01M 4/38; H01M 4/48; H01M 10/0525; H01M 4/62

(52) U.S. Cl. CPC H01M 4/366; H01M 10/0525; H01M 4/625; H01M 4/382; H01M 4/48; G01N 23/201; H01M 2220/20; H01M 2220/30

(57) ABSTRACT

There is provided a negative electrode material for lithium ion secondary batteries having a structure in which in charged and discharged states, a LiₓSi compound (2) exists in the inside of a Li oxide (1) and the LiₓSi compound is dispersed in the inside of the Li oxide. The negative electrode material, in which volume change resulting from charge/discharge is suppressed, has excellent performance as a negative electrode material for lithium ion secondary batteries.

### TECHNICAL FIELD

The present invention relates to a negative electrode material for lithium ion secondary batteries which is capable of having a high charge/discharge capacity and excellent cycle characteristics when used for a negative electrode material of lithium ion secondary batteries, to a method for evaluating the negative electrode material, and further to lithium ion secondary batteries provided with the negative electrode material.

Recently, lithium ion batteries having a light weight and a large charge capacity have been widely used as a second battery used for cellular phones, notebook computers, electric vehicles, and the like along with their size and weight reduction and performance improvement. Further increase in the capacity is required for use in promising next-generation electronic devices with high functions and electric vehicles substitutable for gasoline vehicles. In negative electrode materials, Si-based negative electrodes having a high capacity per unit weight are expected instead of conventional carbon-based materials (graphite carbon, hard carbon and so on). In addition, since the Si-based materials are rich in resources, they will be advantageous from an aspect of future costs.

However, if these materials are used for a negative electrode active material, a large change in volume is caused by repeated charging/discharging cycles, thereby pulverizing the active material, generating cracks on the electrode surface, or peeling off the active material from the electrode or the like. As a result, there is a problem that enough charge/discharge cycle characteristics cannot be obtained because of the decrease in electrical conductivity and the like.

For the above problems, in order to impart electrical conductivity and suppress deterioration due to the volume change, there have been proposed a method of mechanical alloying SiO with graphite, followed by carbonization (Patent Literature 1), a method of coating the surface of silicon oxide particles with carbon by vapor deposition (Patent Literature 2), a method of fusing and adhering silicon carbide to the surface of silicon particles (Patent Literature 3), and method of introducing a metal compound into the inside of silicon or silicon containing particles (Patent Literature 4). In Patent Literature 5, there also is a description that a compound containing Si and O as constituent elements, which is used for a negative electrode, may contain crystallite-phase Si or amorphous-phase Si, but no description is found on states during charging and discharging, and the density, size and the like of the crystallite-phase Si or amorphous-phase Si.

### CITATION LIST

### Patent Literature

Patent Literature 1: Japanese Patent Laid-Open No. 2000-243396
Patent Literature 2: Japanese Patent Laid-Open No. 2002-42806
Patent Literature 3: Japanese Patent No. 4450192
Patent Literature 4: Japanese Patent Laid-Open No. 2010-135336
Patent Literature 5: Japanese Patent Laid-Open No. 2007-242590

### SUMMARY OF INVENTION

### Technical Problem

Any method of the above cited Literatures 1 to 4 was insufficient to overcome volume change resulting from charge/discharge, and peeling off from a current collector due to generation of cracks on an electrode surface which is associated with the volume change, and the like. In addition, a method for suppressing the volume change resulting from charge/discharge is not disclosed in Patent Literature 5.

One aspect of the present invention is directed to provide a negative electrode material for lithium ion secondary batteries in which the volume change resulting from charge/discharge is suppressed. Further, another aspect of the present invention is directed to provide an evaluation method for selecting a negative electrode material having a decrease in volume change resulting from charge/discharge and excellent performance.

### Solution to Problem

One aspect of the present invention relates to a negative electrode material for lithium ion secondary batteries, which has a structure in which, in charged and discharged states, a LiₓSi compound exists in the inside of a Li oxide and the LiₓSi compound is dispersed in the inside of the Li oxide.

Another aspect of the present invention relates to a method for evaluating a negative electrode material for lithium ion secondary batteries, where the material has a structure in which, in charged and discharged states, a LiₓSi compound exists in the inside of a Li oxide and the LiₓSi compound is dispersed in the inside of the Li oxide, wherein, in charged and discharged states of the negative electrode material, at least one of the size, density and inter-particle distance of the LiₓSi within the Li oxide is measured by a small angle X-ray scattering method to evaluate battery performance.

### Advantageous Effect of Invention

According to one aspect of the present invention, a negative electrode material for lithium ion secondary batteries, in which volume change resulting from charge/discharge is suppressed, can be provided. Further, according to another aspect of the present invention, an evaluation method for selecting a negative electrode material having a decrease in volume change resulting from charge/discharge and excellent performance can be provided.

### BRIEF DESCRIPTION OF DRAWINGS

FIG. 1 is a schematic illustration of the structure of a negative electrode material according to an embodiment of the present invention.

FIG. 2 is the respective WAXS results after charge, after discharge at 1000 mAh/g, and after cycle (charged state) using the negative electrode material according to the embodiment of the present invention.

FIG. 3 is the respective SAXS results after charge, after discharge at 1000 mAh/g, and after cycle using the negative electrode material according to the embodiment of the present invention.

FIG. 4 is the respective particle-size distributions after charge, after discharge at 1000 mAh/g, and after cycle using the negative electrode material according to the embodiment of the present invention.

### DESCRIPTION OF EMBODIMENT

An embodiment of the present invention will now be described.

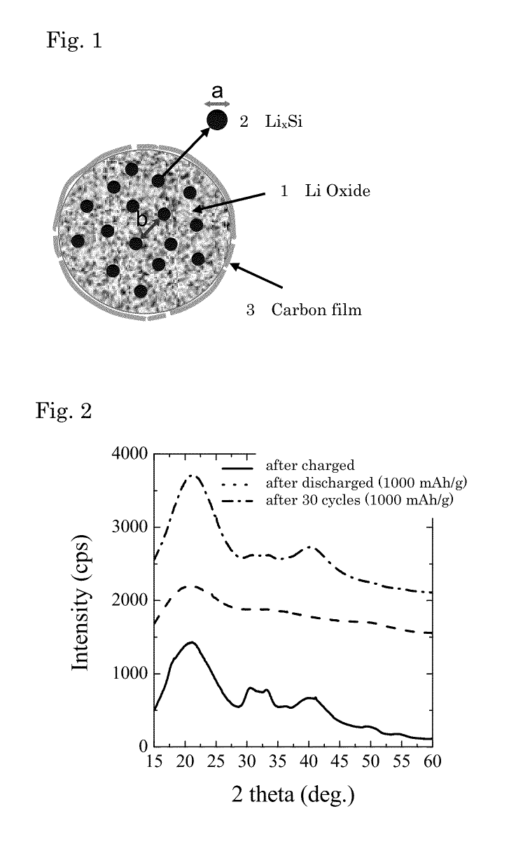

FIG. 1 is a schematic illustration of an example of a negative electrode material according to the present embodiment. The illustration shows a condition that the negative electrode material is in a particle form and a LiₓSi compound 2 is dispersed in a Li oxide 1 after charge. In the present application, the LiₓSi compound denotes a compound represented by the formula LiₓSi, and hereinafter may be simply represented by LiₓSi. As shown in FIG. 1, it is a preferred embodiment that a surface of the negative electrode material is partially or entirely coated with a carbon film 3, but the coating of the surface of the negative electrode material with the carbon film 3 is not essential in the present invention.

An active material, LiₓSi has an average diameter of a (nm) and exists in the form of islands (particles) dispersed in the inside of the Li oxide and with a distance of between the individual LiₓSi islands being b (nm). In this case, the LiₓSi has small density compared to the surrounding Li oxide and can be uniformly dispersed in the Li oxide. Although a and b can respectively have any given values, considering size change on charging/discharging, preferably a is in the range of 0.5 nm to 15 nm, and more preferably in the range of 1 nm to 10 nm, and preferably b is in the range of 1 to 20 nm, and more preferably in the range of 3 nm to 15 nm.

In addition, the particle diameter of the negative electrode material, namely, the Li oxide, is commonly from 10 nm to 100 μm, preferably in the range of 100 nm to 100 μm, and more preferably in the range of 100 nm to 50 μm. If the particle diameter is less than 100 nm, the negative electrode material is deteriorative because of a high proportion of edge structure. If it is 50 μm or more, the material may be practically insufficient because Li diffusion during charging/discharging is liable to be inhibited due to the increased film thickness of the electrode.

As a density of the Li oxide, 1.8 to 3.0 g/cm³ can be used, and as a density of the LiₓSi compound (at charged condition), 0.5 to 1.7 g/cm³ can be used. When the densities of the Li oxide and the LiₓSi compound are within the respective ranges, they can respectively have any given values, but more preferably they are in the range of 2.0 to 2.5 g/cm³ and in the range of 1.0 to 1.4 g/cm³, respectively. Within these ranges, the difference in the densities is properly large, thereby capable of effectively preventing the deterioration due to the size change in charging/discharging.

Further, if the respective densities of the Li oxide and the LiₓSi compound are within the above respective ranges, since the difference in the densities is suitable, as described below, the size, the density, the inter-particle distance of the LiₓSi and the like, and change in the structure due to charge/discharge can be accurately evaluated by small angle X-ray scattering method. For example, the negative electrode material at charged and discharged condition can be evaluated to predict alleviation of a volume change resulting from charge/discharge, peeling off from a current collector due to generation of cracks on an electrode surface which is associated with the volume change, and the like. In addition, a variation in the structure of the negative electrode material can be evaluated before and after a charge/discharge cycle test.

Thus, the negative electrode material according to the present embodiment can be considered to have such effects that because the Li oxide and LiₓSi have the above densities, the structure can be accurately evaluated, and that measures for improving batteries (namely, possible measures not only for the electrode materials but also for the whole battery) can be implemented based on findings obtained from the above evaluation and resultant prediction.

Herein, increase of Li in LiₓSi can decrease the density. The active material LiₓSi can be used in the range of 0<x≦4.4. Specifically, charging is conducted in the range where upper limit of x is up to 4.4. Further, at discharged condition, LiₓSi is used in a range satisfying 0<x.

However, the range of 2<x≦4.4 is more suitable for the charged state, and if x is less than 2 in the charged state, the cycle characteristics are good, but the capacity of charge/discharge is not sufficient and thus practically poor.

As Li oxides, Li₂O, LiOH and LiₓSiO_{y} can be used, and 0<x≦4 and 0<y≦4 can be used in the case of LiₓSiO_{y}.

To produce negative electrode material according to the present embodiment, SiOₓ (0<x<2) is first heat-treated at an appropriate temperature under vacuum, a nitrogen or inert gas atmosphere, or a hydrogen atmosphere to precipitate Si particles in the SiOₓ; and after making a lithium ion battery, the heat-treated SiO is charged to produce a negative electrode material in which the LiₓSi compound is dispersed in the inside of the Li oxide.

When the silicon oxide is first heat-treated under vacuum, an inert gas atmosphere, or a hydrogen atmosphere, a reaction of SiO→Si+SiO₂ allows the distribution of silicon particles and the silicon oxide in the inside of a particle. The temperature of heat treatment is commonly conducted at 600 to 1500° C., preferably at 700 to 1100° C. A temperature of 700° C. or lower is not effective because the formation of Si particles is difficult. In addition, a temperature of 1100° C. or higher is not effective because oxidation takes place due to a small amount of oxygen present in the inside of an electric furnace. Namely, it was found that in the case of employment of the temperature of heat treatment within the range of 700 to 1100° C., and a size change of the LiₓSi in the negative electrode material is small before and after a charge/discharge cycle test the negative electrode material becomes excellent in a cycle characteristic.

Further, as described above, a carbon film also may be formed on the surface of the negative electrode material, which can be formed by sputtering, arc vapor deposition, chemical vapor deposition, or the like. In particular, a chemical vapor deposition method (CVD method) that is chemical vacuum evaporation is preferable because of easeness of control in the temperature and atmosphere for vapor deposition. The CVD method can be conducted by loading a nano-carbon mixture into a boat or the like made of alumina or quartz, or by floating or carrying the mixture in a gas.

In CVD reaction, a carbon source compound can be appropriately selected depending on experimental conditions from those capable of generating carbon by thermal decomposition. For example, hydrocarbons such as methane, ethane, ethylene, acetylene, and benzene, organic solvents such as methanol, ethanol, toluene, xylene, CO, or the like can be used. These can be used by heating to a temperature of 400 to 1200° C. in the presence of, as an atmospheric gas, an inert gas such as argon or nitrogen or a mixed gas of the inert gas and hydrogen.

The flow rates of the carbon source and the atmospheric gas on conducting CVD reaction can be appropriately set in the range of 1 mL/min to 10 L/min, individually. For the carbon source, the range of 10 mL/min to 500 mL/min is more preferable, and as far as it is within the range, more uniform coating can be performed. For the atmospheric gas, the range of 100 mL/min to 1000 mL/min is more preferable. The pressure in range of 10 to 10000 Torr can be used, but it is more preferably in the range of 400 to 850 Torr.

Preferably, the thickness of the carbon film is in the range of 1 nm to 100 nm, more preferably in the range of 5 nm to 30 nm. Sufficient electrical conductivity can be imparted by adjusting the thickness of the carbon film to the above region. If the film thickness is too thin, the electrical conductivity is not sufficient, and if it is too thick, it is difficult to take a sufficient capacity due to the increased volume.

A negative electrode can be formed from the thus obtained negative electrode material (precisely, a precursor of the negative electrode material according to the present invention) to produce a lithium secondary battery using a positive electrode, an electrolyte, and a separator.

As the electrolyte, a nonaqueous solution, containing lithium salts, for example, such as LiPF₆, LiClO₄, LiBF₄, LiA₁O₄, LiAlCl₄, LiSbF₆, LiSCN, LiCl, and LiCF₃SO₃, is used, and these salts can be used alone or in combination of two or more thereof.

Example of the nonaqueous solvents of the electrolytic solution include propylene carbonate, ethylene carbonate, dimethylcarbonate, diethylcarbonate, ethylmethylcarbonate and the like, and these solvents are used alone or in combination of two or more thereof.

As the positive electrode active material, a known lithium-containing transition metal oxide can be used. Specifically, examples of the metal oxide include LiCoO₂, LiNiO₂, LiMn₂O₄, LiFePO₄, LiFeSiO₄, LiFeBO₃, Li₃V₂(PO₄)₃, Li₂FeP₂O₇, and the like.

After assembling the battery, a negative electrode material according to the present embodiment can be formed by at least one charging. The thus formed negative electrode material, as described above, is a negative electrode material in which, in charged and discharged states, a LiₓSi compound exists in the inside of a Li oxide and the LiₓSi compound is dispersed in the form of particles in the inside of the Li oxide.

The structure of the negative electrode material after charging, discharging, charging-discharging or the like can be evaluated for particle size, size distribution, inter-particle distance and the like by small angle X-ray scattering method. Since the negative electrode material according to the present embodiment has a density difference between the LiₓSi and Li oxide, the size, density, inter-particle distance and the like of the LiₓSi as well as its structural change due to charge/discharge can be accurately evaluated by small angle X-ray scattering method.

Accordingly, one embodiment of the present invention also provides a method for evaluating battery performance by measuring at least one of the size, density, and inter-particle distance of the LiₓSi in the Li oxide.

As specifically described in the following Examples, the results by small angle X-ray scattering method can be converted into particle size distribution by curve fitting to determine the size of the LiₓSi. In addition, since peak intensity is lowered when a density difference to the Li oxide of the mother phase decreases, density of the LiₓSi can be evaluated from the density difference to the Li oxide. Specifically, the density of the Li oxide can be determined from the volume and the weight of the thinned Li oxide, while density of a LiₓSi can be determined by curve fitting the obtained small angle scattering spectra assuming the densities of the Li oxide of the mother phase and the LiₓSi.

Further, in actually measured spectra of small angle X-ray scattering method, if particles exist in certain periodicity, curve fitting corresponds to their inter-particle distances, and further scattering intensity wholly affects a volume fraction of the particles. Thus, the inter-particle distance and the volume fraction can also be determined by curve fitting results obtained from small angle X-ray scattering method. In the present embodiment, inter-particle distance and a volume fraction can be calculated by curve fitting, for example, using Rigaku Nano-solver (version 3.4).

In the evaluation method according to the present embodiment, it can first be determined whether a LiₓSi has proper size, density or inter-particle distance by measuring at least one of the size, the density and the inter-particle distance of the LiₓSi after initial charging (e.g., after first charging), thereby a negative electrode material is evaluated. In a negative electrode material excellent in performance, since a LiₓSi in the initial state has a size in the range of 0.5 nm to 15 nm, preferably in the range of 1 to 10 nm, a density in the range of 0.5 to 1.7 g/cm³, preferably in the range of 1 to 1.5 g/cm³, and an inter-particle distance in the range of 1 nm to 20 nm, preferably in the range of 3 to 15 nm, a negative electrode material which satisfies at least one, preferably two or more, and more preferably three of these ranges, can be selected as a negative electrode material excellent in performance.

By the evaluation of the negative electrode material in charged and discharged state, it becomes possible to predict alleviation of a volume change resulting from charge/discharge, and the delamination from a current collector due to generation of cracks on the electrode surface which is associated with the volume change, and thus, to take suitable measures.

Further, a charge/discharge cycle test is conducted, and at least one of size, density, and inter-particle distance of a LiₓSi can be measured before and after the test to evaluate variations thereof, allowing the selection of a material with a small variation as a negative electrode material excellent in performance.

A material having small variations in at least one, preferably two or more, and more preferably three among the size, the density, and the inter-particle size distance of the LiₓSi (namely, a material having degree of variation within a predetermined degree of variation which has been set in accordance with the purpose of use) can be selected as a negative electrode material excellent in cycle characteristics. As an example, generally those having variation of 30% or less, preferably in the range of 10% or less for an initial cycle (e.g., 30 cycles) can be selected as a negative electrode material excellent in cycle characteristics.

Thus, according to the present embodiment, the structure of the LiₓSi in the Li oxide and the like can be evaluated to allow selection of a negative electrode material excellent in performance and further the increased utilization in designing the negative electrode and the whole battery structure.

### EXAMPLES

The present invention will be illustrated in details below by referring to examples. Obviously, the invention is not limited to the following examples.

### Experimental Example 1

### Example

### Production of Negative Electrode and Battery

To a sample (85 wt %) obtained by heat-treating SiO at 1000° C. in Ar and coating with carbon by the CVD method, 15 wt % of polyimide was added, and N-methyl-2-pyrrolidinone was further mixed and sufficiently stirred to prepare a paste. Then, the obtained paste was applied onto a copper foil for a current collector in a thickness of 80 μm. Then, after drying at 120° C. for one hour, press-forming by a roller press was conducted to form an electrode. Further, the electrode was subjected to heating at 350° C. under a nitrogen atmosphere for one hour and punched at a size of 2 cm² to obtain a negative electrode. A lithium foil was used as the counter electrode. To prepare an electrolyte solution, LiPF₆ was dissolved by 1 M in a mixed solvent of a volume ratio of 3:7 of ethylene carbonate and diethyl carbonate. As a separator, a porous polyethylene film with 30 μm thickness was used to produce a lithium-ion secondary battery cell for evaluation.

The obtained cell was set on a charge/discharge tester. Charging was conducted at a constant current of 0.2 mA/cm² until the voltage reached 0.02 V, and it was continued at a decreasing current keeping the voltage at 0.02 V. Charging was terminated when the current decreased to 60 μA/cm². Discharging was conducted at a constant current of 0.2 mA/cm² and terminated when the cell voltage reached 2.0 V, from which the discharge capacity was determined. The initial charge capacity and the initial discharge capacity were 2330 mAh/g and 1650 mAh/g, respectively per active material, and the charging/discharging efficiency was 71%. A sample after charge, a sample discharged by 1000 mAh/g following the initial charge, and a sample in a final charged state which had been subjected to a 30-cycle test with discharge by 1000 mAh/g following charge were prepared to conduct SAXS (Small-angle X-ray scattering) measurement and WAXS (Wide-angle X-ray diffraction) measurement for each sample.

### (Results of SAXS and WAXS Measurement)

FIG. 2 is the results of WAXS measurement. Broad peaks in the neighborhood of 2θ=20° and 40° are the peaks of Li₁₅Si₄. Further, a broad peak in 2θ=30° to 35° is considered to that for a reversible Si compound in a phase such as Li₇Si₃ and Li₇Si₁₂, because the peak has disappeared by discharge by 1000 mAh/g. In addition, after 30 cycle charge/discharge, the peak had the same shape and there was little structural deterioration.

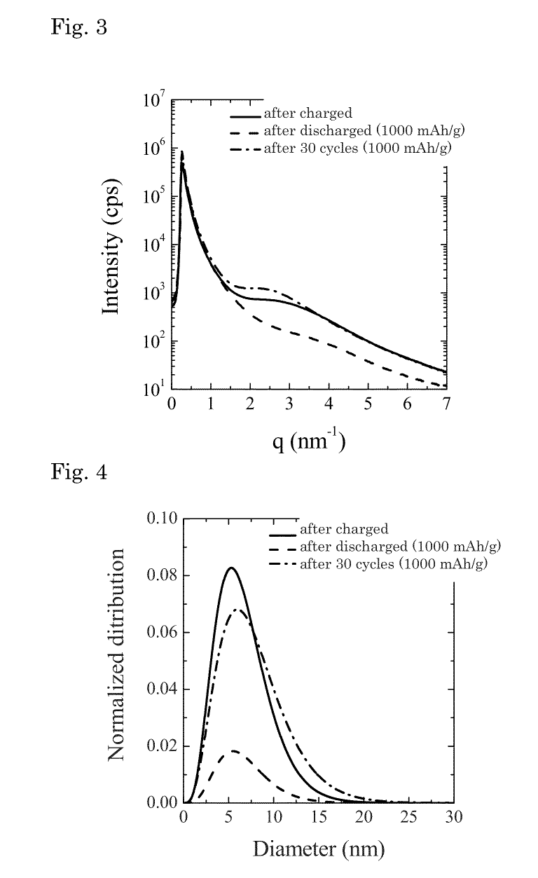

FIG. 3 is the results of SAXS measurement. Scattering peaks were observed in the neighborhood of q (q=4π sin θ/λ)=1.5 to 3. Their scattering intensities remarkably decreased after discharge. This is because the difference in the densities between the silicon particles and the Li oxide (Li₂O and LiSiO₃ and so on) of the mother phase was decreased due to decrease of Li. FIG. 4 shows particle size distribution converted from those peak shapes by curve fitting using Rigaku Nano-solver (version 3.4).

The analytic results are also shown in Table 1. Before and after charge/discharge, the changes were observed from 6.7 nm to 7.8 nm for the average particle size, from 9.4 nm to 11.0 nm for the shortest inter-particle distance, and from 56.8 to 57.3 nm for the volume fraction. Here, from SAXS measurement results, the distribution of the average particle size of 6.7 nm is that of LiₓSi (Li₁₅Si₄, Li₇Si₃ and so on). By conducting 30 cycles, it can be seen that the particle size of the LiₓSi slightly increased. It appears that as the volume fractions were the same, LiₓSi has slightly enlarged and the respective inter-particle distances has been widened. Further, after discharge, although the volume fraction decreased, the particle size and the inter-particle distance were almost equal to those after charge, respectively.

In addition, there was almost no change in the LiₓSi density before and after the cycles, as clearly seen from the fact that there was no change in a diffraction peak at 40° in FIG. 2.

TABLE 1

| | Average particle | Shortest inter- | |
|---|---|---|---|
| | size | particle distance | Volume fraction |
| | (nm) | (nm) | (%) |
| After charged | 6.7 | 9.4 | 56.8 |
| After discharge | 6.7 | 7.4 | 12.0 |
| After 30 cycles | 7.8 | 11.0 | 57.3 |

### (Results of Transmission Electron Microscopy)

A sample after charge, a sample discharged by 1000 mAh/g following the initial charge, and a sample charged after 30 cycles (1000 mAh/g) were respectively subjected to focused ion beam (FIB) processing to observe each of them by a transmission electron microscope. As a result, LiSi particles with a black contrast were observed. In this case, the average particle size was 1 to 10 nm and the shortest inter-particle distance was about 3 to 15 nm, and the averages thereof were 7 nm and 8 nm, respectively.

### Experimental Example 2

Samples were produced by varying the heat-treatment condition of Experimental Example 1 to conduct evaluation using coin-type cells. The temperature of heat treatment was set at 0° C. (untreated), 600° C., 700° C., 800° C., 1100° C., and 1200° C., and coating with carbon film by the CVD method was conducted. A sample after charge and a sample charged after 30 cycles (1000 mAh/g) were respectively produced to conduct SAXS and WAXS measurements. When the difference in particle sizes between after-charge and after-cycle (charged) was compared with that at 1000° C. heat treatment, change in the particle size was small and excellent cycle performance was shown in the heat treatment between 700 to 1100°.

### Experimental Example 3

In order to change LiSi density, cycle evaluation of the coin-type cell, which was produced according to the conditions of Experimental Example 1, was conducted by varying a charge amount. Each of phases of LiSi, Li₁₂Si₇, Li₇Si₃, Li₁₃Si₄, Li₁₅Si₄, Li₂₁Si₅, and Li₂₂Si₅ was prepared by controlling the charge amount in the range of 400 to 1400 mAh/g. As a result, in cycle characteristics, a Li₂Si₅ composition showed a large decrease in a charge/discharge retention ratio compared with other compositions.

### REFERENCE SIGNS LIST

1 Li oxide
2 LiₓSi compound
3 carbon film

1. A negative electrode material for lithium ion secondary batteries, comprising a structure in which, in charged and discharged states, a LiₓSi compound exists in the inside of a Li oxide and the LiₓSi compound is dispersed in the inside of the Li oxide.

2. The negative electrode material for lithium ion secondary batteries according to claim 1, wherein the Li oxide has a density of 1.8 to 3.0 g/cm³ and the LiₓSi compound has a density of 0.5 to 1.7 g/cm³ at charged condition.

3. The negative electrode material for lithium ion secondary batteries according to claim 1, wherein in the LiₓSi compound, 0<x≦4.4 is satisfied.

4. The negative electrode material for lithium ion secondary batteries according to claim 1, wherein the Li oxide is Li₂O or LiₓSiO_{y} where 0<x≦4 and 0<y≦4.

5. The negative electrode material for lithium ion secondary batteries according to claim 1, wherein the LiₓSi compound has a size in the range of 0.5 nm to 15 nm and an inter-LiₓSi distance in the range of 1 to 20 nm, and the Li oxide has a size of 100 nm to 100 μm.

6. The negative electrode material for lithium ion secondary batteries according to claim 1, wherein the negative electrode material for lithium ion secondary batteries is coated with carbon.

7. A method for producing a negative electrode material for lithium ion secondary batteries, comprising the steps of:
heat-treating silicon oxide at 700 to 1100° C. under an inert gas atmosphere or a hydrogen atmosphere to form a structure, in which silicon particles are dispersed in silicon oxide; and
charging the heat-treated silicon oxide used as the negative electrode in the presence of lithium ions to produce a negative electrode having a structure in which, in charged and discharged states, a LiₓSi compound exists in the inside of a Li oxide and the LiₓSi compound is dispersed in the inside of the Li oxide.

8. A method for evaluating a negative electrode material for lithium ion secondary batteries, wherein the material has a structure in which, in charged and discharged states, a LiₓSi compound exists in the inside of a Li oxide and the LiₓSi compound is dispersed in the inside of the Li oxide,
the method comprising measuring at least one of the size, density and inter-particle distance of the LiₓSi compound within the Li oxide using a small angle X-ray scattering method in charged and discharged states of the negative electrode material to evaluate battery performance.

9. The method for evaluating a negative electrode material for lithium ion secondary batteries according to claim 8, comprising:
conducting a charge/discharge cycle test of the negative electrode material;
measuring the size of the LiₓSi in the Li oxide before and after the charge/discharge cycle test by the small angle X-ray scattering method; and
evaluating battery performance based on the magnitude of change in size.

10. A lithium ion secondary battery comprising the negative electrode material for lithium ion secondary batteries according to claim 1.
